(19) United States
(12) Patent Application Publication
(10) Pub. No.: US 2006/0223712 A1
(43) Pub. Date: Oct. 5, 2006

(54) Transaction processing telecommunications system

(76) Inventor: Valery Vinarov, Palatine, IL (US)

Correspondence Address: CARDINAL LAW GROUP, Suite 2000, 1603 Orrington Avenue, Evanston, IL, 60201, US

(21) Appl. No.: 11/396,664

(22) Filed: Apr. 3, 2006

Related U.S. Application Data
(60) Provisional application No. 60/667,305, filed on Apr. 1, 2005.

(51) Int. Cl. C04B 35/45

(52) U.S. Cl. 505/126

(57) ABSTRACT

A system employing a plurality of service independent building block components, wherein each service independent building block component is exclusive of being strictly associated with any particular type of service. The plurality of service independent building block components are used in a structural hierarchy for purposes of providing a plurality of different services across a plurality of heterogeneous domains.

### RELATED APPLICATION DATA

This application claims the benefit of U.S. Provisional Application Ser. No. 60/667,305 filed on Apr. 1, 2005. The entirety of the application is hereby incorporated by reference

### TECHNICAL FIELD OF THE INVENTION

This invention relates to telecommunications systems and more specifically to processing transactions within a telecommunication system.

### BACKGROUND OF THE INVENTION

Historically, the evolution of wireless network infrastructures has been proprietary and voice centric. As incumbent infrastructure vendors have grown, they added significant cost and complexity to the core network. Wireless carriers (the customer) have been frustrated with escalating costs and growing dependence on traditional vendors. Furthermore, carriers are in a rapidly changing service business. The time and cost required to develop, implement and add service features has been and continues to be one of the most critical issues facing the wireless market.

Service providers strive to offer basic and enhanced communications services that work seamlessly across the PSTN and wireless networks to host media access. However, at the same time, they don't want to invest in a platform that will become obsolete as new services, technologies and protocols are introduced.

Adding to the problems with the established wireless network is that current communications market conditions, especially in the government sector, often have extreme levels of segmentation, diversification and irregular integration of various communication technologies and extremely high level of communication resource duplication. Still further, current wireless infrastructure is not flexible enough to meet market demands. With so many hardware and software elements to manage, implementing change is often, at best, sluggish and inefficient.

Furthermore, the wireless communication infrastructure equipment is reliant on proprietary hardware and software, CBSC/BTS centric hierarchical architecture utilizing specialized, dedicated processing. Key system elements due to their complexity, specialization and dedication to particular market segment prohibit effective design reuse and development cost savings through implementation of true platform development model. Inherent qualities of hierarchical system architecture further impose additional costs on design and implementation of evolving technologies, lead to cumbersome (cut corners) add-ons, complication of already chaotic designs and further system reliability degradation and increased cost of ownership.

What is desired, therefore, is a telecommunications system that will provide low cost, non-proprietary solutions which enhance rapid development and deployment of new services.

### SUMMARY OF THE INVENTION

One form of the present invention is a plurality of service independent building block components, wherein each service independent building block component is exclusive of being strictly associated with any particular type of service, and means for using the plurality of service independent building block components in a structural hierarchy for purposes of providing a plurality of different services across a plurality of heterogeneous domains.

The aforementioned forms and other forms as well as objects and advantages of the present invention will become further apparent from the following detailed description of various embodiments of the present invention read in conjunction with the accompanying drawings. The detailed description and drawings of the various embodiments of the present invention are merely illustrative of the present invention rather than limiting, the scope of the present invention being defined by the appended claims and equivalents thereof.

### DESCRIPTION OF THE DRAWINGS

FIGS. 1-5 are schematic illustrations of one embodiment of a transaction processing telecommunication system.

### DETAILED EMBODIMENTS OF THE INVENTION

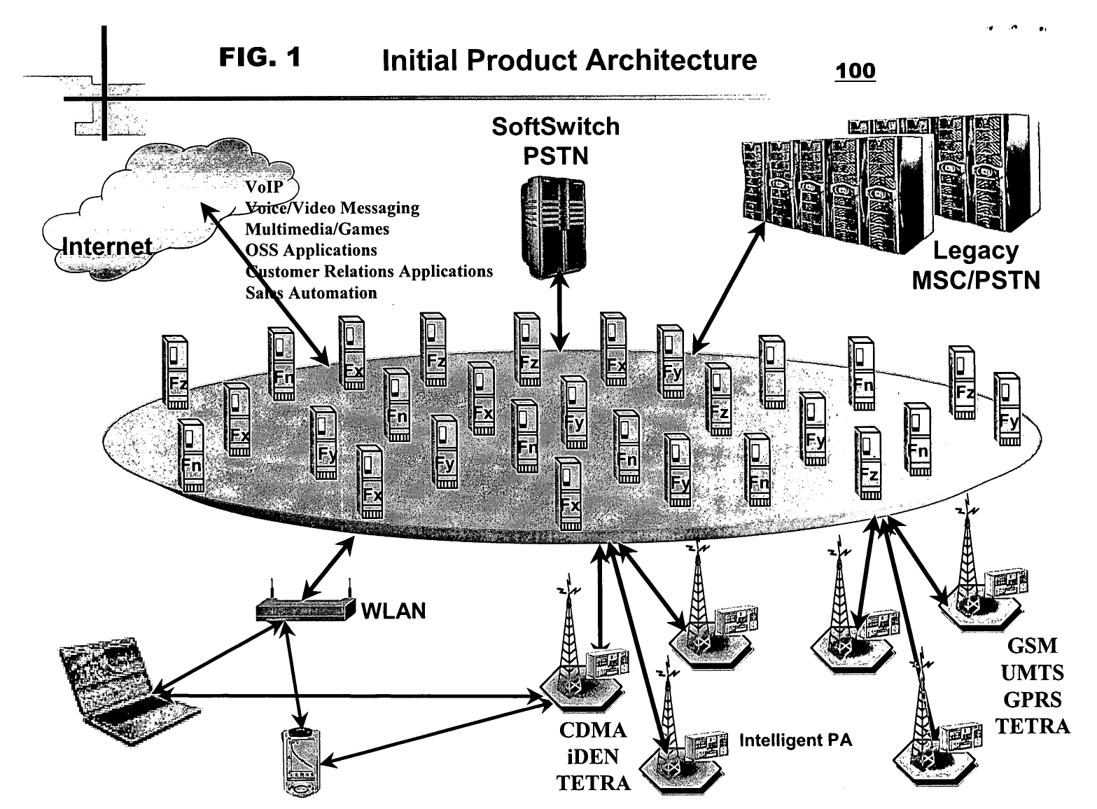

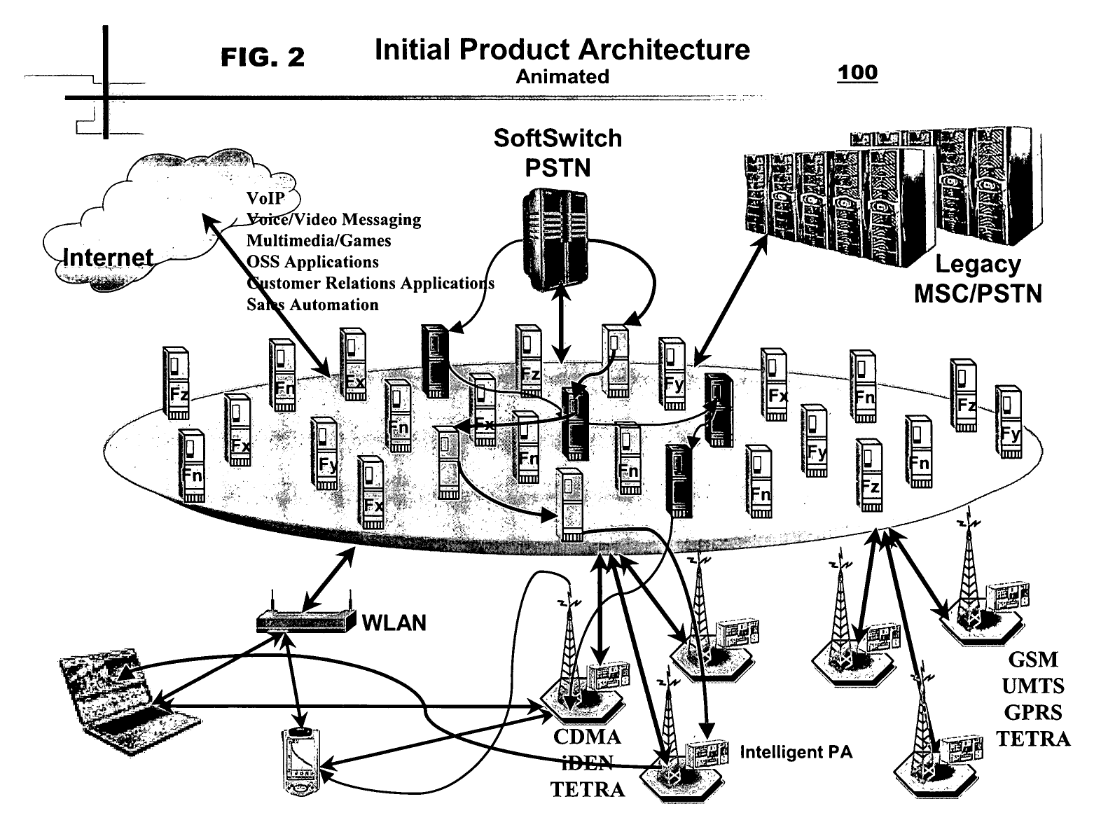

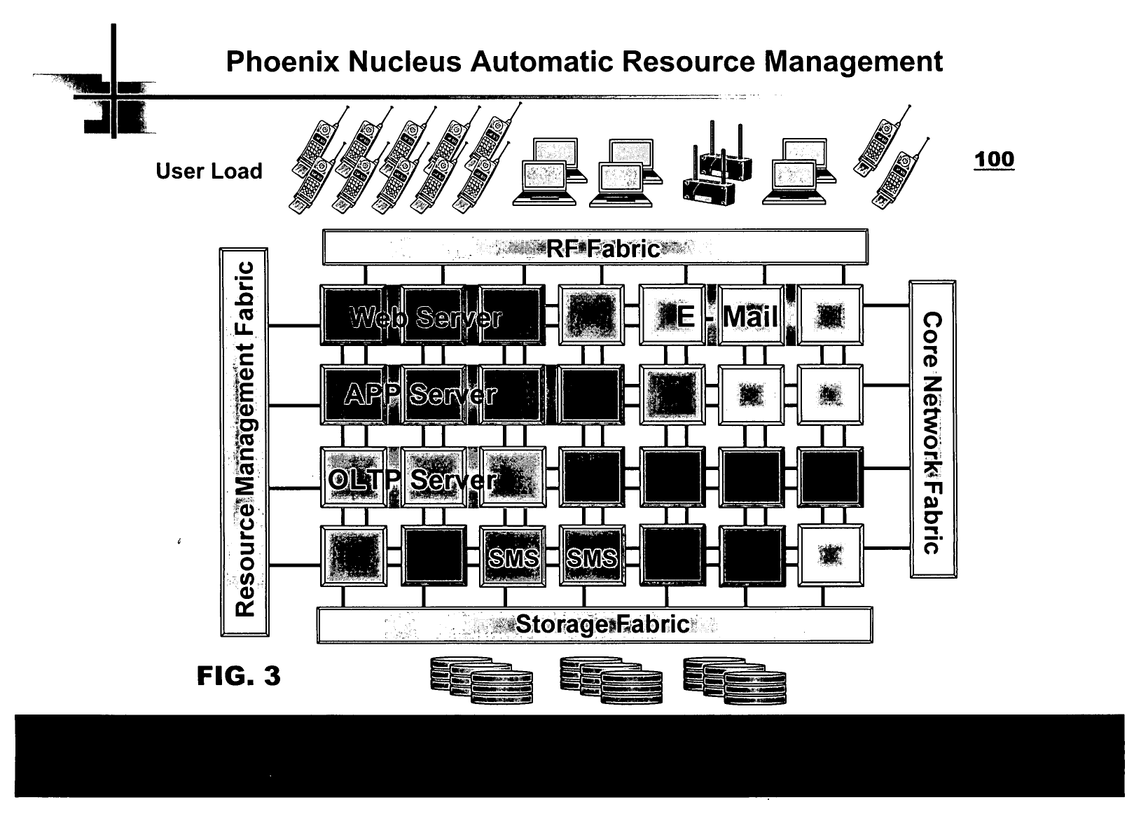

FIGS. 1 to 5 illustrate one embodiment of the telecommunications system 100, according to the present invention.

Referring to FIGS. 1-3, the unique properties of the telecommunications system environment are derived from a simple assumption—any and all telephony sessions (voice and/or data) are composed of a series of transactions and therefore, telecommunication environment implementation must be designed for transaction processing. Each transaction may consume the services of a multitude of servers: Application Server, Queue Server, Device Monitor Server, Resource Manager Server, Soft Switch Server, OSS Server, etc. Telecom transactions are typically state machine driven which should respond within some real-time constraints with signaling information, data payloads, and/or applications.

Furthermore, these transactions can be decomposed into small, primitive or fundamental objects/modules, to collectively handle, for example: Call Processing (CP), Mobility Manager, Power Control, Scheduler, RLP (Radio Link Protocol), AMC (Automatic Modulation & Coding), Hybrid ARQ (Automatic Retransmission Query), Air Interface Specific Handoffs (CDMA, GSM, UMTS, TETRA, etc.), Modem Resource Management, Beam Switching Management, Alarm Management, Redundancy/Routing Management, Authentication, Provisioning, Billing, etc. Many of these cross technology modules share common underlying functionality that is further decomposed.

This methodology of transaction decomposition into simple modules is extremely useful. The primitive or building block functions can be created in such a way that there is a common approach to how these elements can be instantiated and executed. Thus there is now the ability to build a network primarily of general purpose serving nodes capable of being loaded with appropriate functionality to perform some transaction or portion thereof. The processing nodes then become free resources which can be used to improve the system service availability and performance through process management techniques. Not only can this capitalize off a more resilient distributed processing architecture, but it can also benefit from the parallel processing potentials for performance and error handling enhancements. A simpler piece of code enhances configuration, maintenance, debugging, security, performance optimization, re-use and integration. It enables institutionalization of a true Platform Development paradigm, which is flexible in design and capable of capturing new service needs in a common manner, thus securing development cost savings. The flexible distributed architecture of the telecommunication systems environment enables ease of scaling, both large and small, to accommodate the broad range system configurations utilizing a myriad of processing platforms and associated support elements keyed to the size, cost, and performance demands of the system.

In order to fully realize the power of telecommunications system 100 as an architecture for creating a telecommunication system, it is important to understand the concept of software fragmentation and how it relates to abstraction and automation:

Software fragmentation into micro-primitives decouples the once-fixed dependencies between applications, the operating environment, the hardware and software stack on which they run. Once decoupled, the resources in each of these stacks can be automatically and invisibly allocated and reallocated through software, thus achieving better efficiency and flexibility. Fragmentation enables the abstraction of pools of resources, setting the stage for powerful automation and easy manageability.

Abstraction enables the management of components, or groups of components, to be raised to a simpler, more directly useful level. For example, from the explicit management of RNC to simply managing data files; or from configuring forward link to simply specifying the requirements for the service itself. Abstraction hides detail, meaning fewer steps to get more done. One important benefit of abstraction is that there are fewer things to explicitly administer, reducing human errors and management costs while improving agility.

Automation is what computers do best. Automation means predictability, control, reduced errors, lower costs, and increased responsiveness. Automation makes fragmentation real because computers do the work in translating the old, discrete components of our current view into the new higher-level abstractions.

Fragmentation of dynamic, shared resources is perhaps the most critical property of system 100, determining the system, computing, storage, and network resources needed from a high-level definition of services. System 100 helps to ensure flexibility in the choice of resources used and enables generic resource utilization.

System 100 creates a single, tightly integrated super-computer like environment by partitioning all of the compute, storage, and network resources needed to deliver a communication session. With system 100, telecom operators have one system to manage, one system to change, without sacrificing the scalability, availability, and security of a distributed architecture. By making networks of systems operate as one computer, system 100 delivers a number of important benefits:

Increased equipment utilization. System 100 naturally enables server and service consolidation on a much broader basis than previously possible. Such network consolidation will enable increase of the utilization rate of entire wireless infrastructures.

Increased agility and reduced management complexity. System 100 architecture reduces the number of infrastructure components requiring explicit management or configuration, thus, speeding-up the deployment and redeployment of services.

Reduced financial risk. Under the utility pricing models made possible by system 100, resources can be accurately allocated and paid for (on transaction bases) in direct proportion to the amount consumed.

Scalability without proportionate growth in management costs. System 100 allows management expense to scale in proportion to the number of services provided—not with the far larger and more volatile number of discrete components that make up a system.

The transaction processing telecommunications system 100 (system 100) provides operators with significant improvements in critical aspects of their business, both bottom line and top line. System 100 addresses bottom line by focusing on both capital expenditures and operating costs. The highly incremental nature of the architecture allows operators to grow their systems according to their needs, addressing the needs of both low-capacity/high-coverage “rural” conditions as well as high-capacity/low-coverage “urban” settings. Likewise, an emphasis on a “software-defined” system allows for commoditization of key components in the system, further reducing capital requirements. Operations expenses are managed through a coherent emphasis on operability that permeates the architecture. Finally, a focus on services, that is, what do the operators customers want to do with the system, is enabled by this approach.

System 100 creates a single, tightly integrated super-computer like environment by partitioning all of the compute, storage, and network resources needed to deliver a communication session. With system 100, telecom operators have one system to manage, one system to change, without sacrificing the scalability, availability, and security of a distributed architecture. By making networks of systems operate as one computer, System 100 delivers a number of important benefits.

Increased Equipment Utilization

System 100 enables server and service consolidation on a much broader basis than previously possible. Such network consolidation will enable a significant increase in the utilization rate of wireless infrastructures by increased agility and reduced management complexity. System 100 architecture reduces the number of infrastructure components requiring explicit management or configuration, thus, speeding-up the deployment and redeployment of services.

Service Centric Architecture

System 100 architecture has advantages in many areas such as robustness, scalability, flexibility, and adaptability. Through the use of distributed processing techniques and component based service creation environments, the telecommunication system attains a Software Defined System status, with the ability to be service-centric, not simply a service bearer. System 100 has the ability to build services from fundamental service building block components, which can be suitably applied to various service domains and to provision these services on an as needed basis in response to the user population service requests. This approach creates a system which will be in constant tune with the growing needs of the end users in an efficient, robust service offering. The components of the service can be handled by generic processing resources that benefit from the ability to leverage current off-the-shelf processing technology capabilities and cost savings. The service needs of users, the telecommunications capabilities of subscriber devices, and adaptable system processing create a fusion of opportunity to mold the system configuration to best meet the service needs.

The component model configuration of the service environment affords greater flexibility in creating services. Services historically have existed as monolithic service instances that were created to provide a unique service offering. While this could result in a service offering that performed adequately regarding the delivered quality of the stated service to the user, it generally was difficult to maintain with modifications to support new needs of the user or to correct defects in the service implementation being costly and generally capable of inducing unforeseen further defects. Additionally, the service was narrowly defined to address a specific need, and generally could not be easily adapted to new uses. With system 100's new approach, services now become combinations of well-defined smaller, service independent building block (SIB) components. The value of the SIB is that it is not strictly associated with a particular service, and can be utilized for many different services across multiple heterogeneous domains. One can compare this to the ability to create many different and unusual structures with a simple collection of Lego™ building blocks. Where the blocks can be used to build a house now, these same blocks can be used to build a boat later. New services can be created using defined SIBs by combining the SIBs in a different order. New SIBs can be added to the overall library of components to allow new and different services to be created. The SIB structure itself can be viewed as a hierarchy, with sets of basic SIBs being used to create services and higher level SIBs, which themselves can be used to create services and higher level SIBs, etc. The service creation of modifications to services and the generation of new services becomes an easier endeavor due to the services created initially acting as the baseline.

With services created using a component architecture, there is ability to decompose the service into separate executable pieces and to process these executables on one to potentially many processing resources. This affords a great opportunity for scalability and flexibility regarding the processing resources needed to faithfully fulfill a service need, as well as a means to address enhanced availability. The service execution can be spread across many processing resources, with each of the processing resources acting as a processing pool itself, thus greatly enhancing the service reliability.

Telecommunication systems have traditionally addressed large subscriber population sizes, hundreds of thousands to tens of millions. Due to the high cost of proprietary processing structures needed, profitability required large populations of users. Growing very much larger, or trying to address user populations much smaller than this generally was meet with less than desired cost penalties. System 100's scalability is one of its key attributes. Not only is there the ability to scale up to exceed the population space generally addressed by the legacy telecommunication systems, but System 100's approach affords a cost effective offering for the small user population needs, addressing untapped market potential. System 100's services can be allocated to as many or as few processing resources as desired. There is architectural ability to scale the system configuration to meet cost goals for a continuum of system sized from very small to exceptionally large.

One critical aspect to operator acceptance is the ability for system 100 to improve an operator's revenue stream. System 100's system enables operators to be timely and agile in delivering new service capabilities to customers. The architecture and API of system 100 allows functions and new services creation and deployment flexibly and on demand. By allowing the system to flexibly create, deploy, and interconnect these services, the operator is not tied to any particular vendor (or set of vendors) and their “release cycle,” “business priorities,” or other issues outside of the operator's direct control. Using the system 100 open architecture and APIs, an operator can commission a 3^{rd} party to create new functions and integrate these functions into the total system 100 framework—including the operations aspects. These functions can collaborate with peer functions on mobile devices, infrastructure, or other System 100 components to extend the existing capabilities and provide new ones. This allows operators to differentiate themselves (for leadership positions), or rapidly deploy answers to their competitor's leadership services.

System Management and Operations

Operations focus is in at least two areas: System Management and System Availability. The System Management focus provides operators with a coherent, simple, and low-cost way to operate the system. Note that because the focus of System 100 is to distribute functions among a variety of servers, management of this kind of system becomes a new thing for operators used to managing servers and functions as opaque, atomic blocks. The new approach requires new management approach, diverting resources from one kind of function to another, or perhaps understanding when and how to add new servers to support capacity requirements of the system. These are appropriate functions for operators to be managing. Likewise, the “infrastructural” aspects of the system—configuration, communication, etc,—are automated. The operator only needs to intervene when a catastrophic event occurs, and then only if the automated routines are unable to get by on their own. These automated actions will be looking for minimal intervention—“help me get over this bump”—and will then continue to repair any issues in the system. A concern may exist that such automation is difficult, extraneous, or unproven. Such automation difficulty is a direct result of being an afterthought, or “bolt-on” addition to a system. System 100 includes automation inherently and consciously. A critical aspect of the system is being able to manage the flexibility of function location, and hence an operations-focus for such automation is a natural extension of the expected capabilities of the system. As such, these automated routines are not extraneous. Indeed, it is safe to claim that the entire system approach fails if such routines are not available, and hence this is a principal focus of the development effort to keep System 100 simple, rational, and coherent.

System Scalability and Availability

System 100 elements provide a flexible alternative to traditional voice centric systems. Its software modules run on standard computing platforms, which enable nearly linear performance enhancements by the simple addition of processors and memory. This makes it possible to distribute the discrete functions of the architecture throughout the network, providing greater scalability and enhanced reliability through system redundancy. If a single element fails, crucial network operations are unaffected.

Flexible distributed architecture of the system 100 telecommunication environment enables ease of scaling, both large and small, to accommodate the broad range system configurations utilizing a myriad of processing platforms and associated support elements keyed to size, cost, and performance demands of the system.

Proposed component architecture allows the system to be decomposed into primitive functional modules for embedding into very robust systems. Unique software flexibility is leveraged (i.e. configuration available on many levels for many users, interoperability with other software components) supporting broad requirements spectrum from small rural operator in Siberian village (voice, fax, text) to large metropolitan operator supporting high levels of automation, business software integration and complex OSS software.

The System Availability focus is another natural attribute of system 100's architecture. The system resides on a variety of small commodity processing elements allowing it to manage itself around failures. Managing around failures is one of the architectural advantages of System 100. Similar to other highly redundant systems (e.g., RAID), using a system approach combining small, inexpensive, parts provides an inexpensive, but highly reliable system has been proven. Making services provided by the system from user to user “independent,” at least from an availability perspective, maximizes system performance for the majority of users. A failure in a given function will, without a doubt, affect some users, but in such a way that minimizes the impact to a negligible number of users. In existing deployed hierarchical systems, with their strong coupling among box, function, and location/physical structure of the system, failures affect geographic regions—all users in those areas lose service. The system 100 approach minimizes this effect to practically nothing.

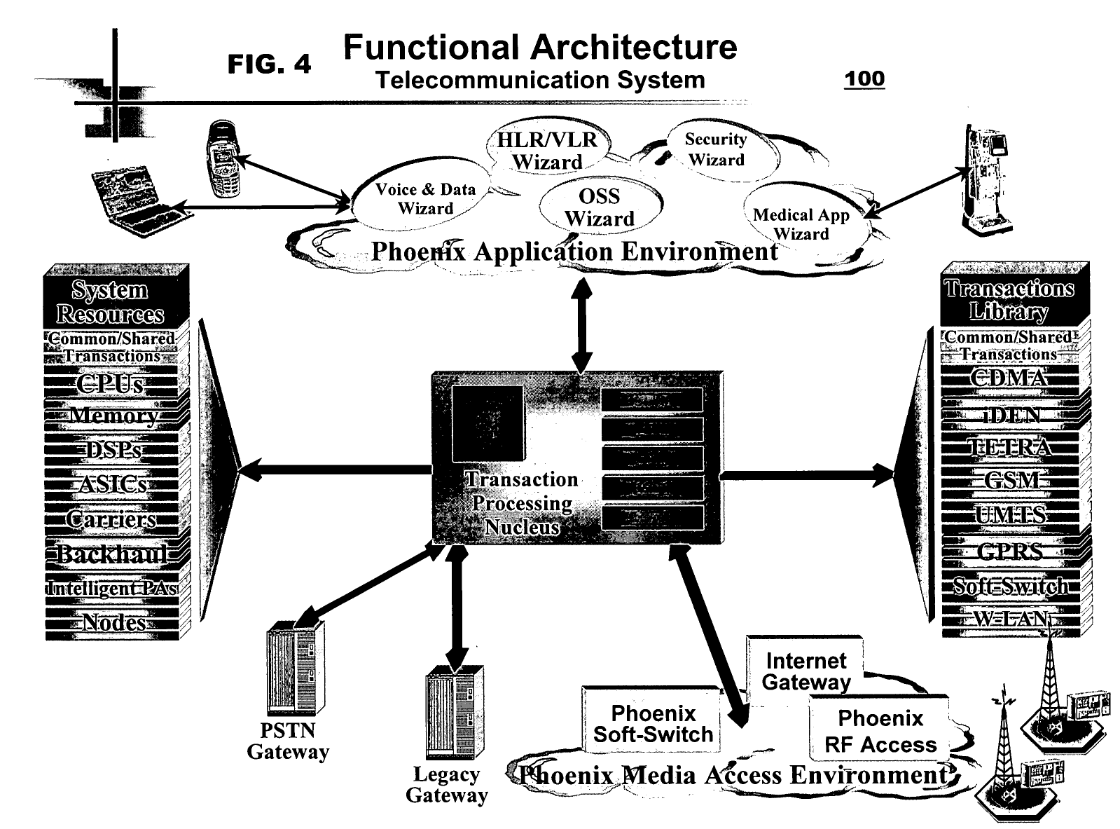

Referring to FIG. 4, telephony equipment is currently reliant on proprietary hardware and software to power everything from PBX's, voicemail systems, mobile clients, and gateways to large call-centers and carrier infrastructures. System 100 operating system will integrate the functionality of common applications into a highly flexible and broadly functional system operating on commodity hardware.

Application Environment—The application environment employs distributed transaction processing architecture supporting multitude of a new services platform independent. This environment controlled by application server managing user interaction over the telecommunication system. Initial system release will support the following applications:

Integrated Messaging—voice & data messaging system that integrates with other data messaging systems, such as web-based mail or may be just an MTA through the Post Office Protocol.

Automated voice response to allow callers to get to the information or people they need.

HLR/LR

Operations Support Systems—OSS/BSS

The vision for future system evolution includes the following applications:

Medical, Manufacturing, Supply chain management and Sales Automation—Integration of voice and web applications for automated order processing.

IP based Transaction Processing Manager (Nucleus)—The Nucleus stores the state and transaction data of all transactions that are registered with it. The Nucleus is a set of redundant servers that not only share the data, but handle any failures occurring on the servers that generate transaction data, including the TPM itself. For instance, it might respond to the untimely demise of Fx by launching various transactions on Fy based on the last known state of all Fx's registered transactions.

Control servers: All of the control servers (Transaction Processing Nucleus, for example) will use the same trunk class libraries for interfacing to drivers and protocol stacks. They all are scriptable and capable to manage call control. However, they are functionally and structurally quite separate. Application servers/wizards will interface to people, Nucleus will communicate with programs. The control servers should use each other as a set of cooperating processes. For example, Voce & Data Wizard may ask Nucleus to perform call control. Medical Wizard will ask Nucleus to present interfaces, etc. The separation of control servers will enable ability to support large, highly optimized, distributed systems.

Resource allocation Manager. System 100 performs all of the necessary functions for dynamic resource allocation. It maintains an inventory of all resources. It processes allocation requests and preemptively manages resources. It enforces policies for optimal resource distribution. And it collects and returns unused resources back into the pool. Resource Allocation Manager does this automatically and invisibly to both services and end users.

Transactions Libraries—All of the communications protocols (CDMA, UMTS, GSM, TETRA, GPRS, W-LAN and etc) as well as device drivers and stacks will be decomposed into primitive objects/modules and will be stored in libraries. In cases where a transaction is not hardware dependent, it may be executed upon any server environment. In other cases the transaction may be linked to a core server.

The driver, codec, and client call control libraries are being pursued, as well as several specialized libraries and servers for interfacing to switches of various types, business logic servers, etc. In the interest of configurability and rapid application development, each server will be completely programmable, therefore, libraries will be divided where distinct server-side scripting languages are created.

A primitive application component might have a certain structure, such as a flat xml file. As a component, it will be stored in a database, passed from one server to another, modified, and interpreted in one or more environments. We are planning to use CORBA for this type of object brokering. Some nice features of CORBA such as polymorphic messaging and method invocation will be very useful.

Soft-Switch: Employs transaction processing architecture for call session treatment, signaling, control, and service creation across multiple access media: wired, wireless and broadband. With its open, standards-based architecture, the soft-switch lends itself to rapid customization for new call-control functions, support of a new emerging technologies and a variety of end-user and service provider network services.

Soft-switch primitive elements combined into transaction processing provide a flexible alternative to traditional centralized switching. The soft-switch primitive software modules run on standard generic computing platforms, which enable nearly linear performance enhancements by the simple addition of processors and memory. This makes it possible to distribute the discrete functions of the soft-switch throughout the network, providing greater scalability and enhanced reliability through system redundancy. If a single element fails, crucial network operations are unaffected.

The Soft-switch includes two key elements: back-end servers and session agents. Back-end servers deliver critical functions such as accounting, billing, directory mapping, and provisioning. Session agents provide distinct functionality, including media control and management, session control functions, and multi-protocol PSTN/IP interfaces for SIP, H.323, Megaco/H.248 and SS7.

Using standard Media Gateways allows:

Access to legacy/incumbent PSTN, inter-operability with existing communication services;

Bypass of existing PSTN for services staying within the System 100-enabled system, minimizing interconnection fees;

Delivery of expected standard services (e.g., conference bridges, tone decoders, announcements, . . . ) to users, supporting their demands; and

An architecturally-sound attachment point for new services consistent with the general distributed approach of the network, continuing the theme of demand-driven growth of services and capability independent of the “boxes” providing the services

System 100 is practical, open, highly flexible, scalable and configurable and will establish unprecedented availability. Proposed system component architecture will allow the system to be defragmented for embedding into a very tight sub-systems—it will be able to run on only one or multitude of servers.

Proposed Telecom Operating System will support a wide variety of resources, hardware and software platforms and communication mechanisms including VoIP and PSTN. It will provide mechanisms supporting interoperability with existing legacy systems.

In all cases the unique flexibility of system software will be leveraged (i.e. configuration available on many levels for many users, interoperability with other software components).

Interoperability sums up the single most important challenge; designing robust interfaces to support alternate versions of any given server, enabling its hot-swap introduction into the system.

The ability to combine functionality into one process—Transaction, is a practical necessity (this is often the case with application and media servers). The ability to strip a server down into simpler stand-alone components is extremely useful. A simpler code simplifies configuration, maintenance, debugging, security, performance optimization, re-use and integration. Ability to scale components up and down to accommodate the broad range of machines and operating environments justifies several potential abstraction layers.

The operating environment of the future must be capable of integrating an entire system's resources, reducing complexity and facilitating the deployment of new services. The key feature of this new operating environment is to knit together a broad set of resources into a coherent, integrated whole that Sun refers to as a fabric operating environment.

Scalability Range:

System 100 Operating System will be highly scalable and configurable. Multiple system components will be designed to increase the reliability of existing applications. Proposed component architecture will allow the system to be decomposed into primitive functional modules for embedding into very robust systems. Unique software flexibility will be leveraged (i.e. configuration available on many levels for many users, interoperability with other software components) supporting broad requirements spectrum from small rural operator in Siberian village (voice, fax, text) to large metropolitan operator supporting high levels of automation, business software integration and complex OSS software.

The system 100 comprises a design that is practical, open, flexible, scalable, and interoperable.

The system 100 will support large number of new servers, clients, functional component libraries, and an extensive library of applications

The system 100 will support a wide variety of telephony resources and communications mechanisms including VoIP and PSTN communications. The system 100 will provide mechanisms for communicating with legacy systems.

Integrated messaging system—no new functionality needs to be developed. The system 100 will only need to write a document that describes how a large number of servers (web, mail, sms, ivr, etc., etc.) can be configured to cooperate to carry out the desired functionality.

Modularity is a dominant design challenge

Having the ability to combine functionality into one process can be a practical necessity (this is often the case with application and media servers). However, having the ability to strip a server down into simpler stand-alone components can also be extremely useful. A simpler piece of code generally simplifies configuration, maintenance, debugging, security, performance optimization, re-use and integration. Add to this the requirement for system 100 components to scale up and down to accommodate the broad range of machines and operating systems running system 100 software, and can justify several potential abstraction layers.

A component model for the system 100 will be helpful for project management reasons alone. Benefits of component/function based architecture—platform, ease of modification and maintenance, use of Corba.

Telecom resources (protocol stacks, drivers, etc.) are typically state machines which should respond within real-time constraints with signaling information and/or data payloads, and our applications need to be able to act in kind to use them. We can also assume that we have observed the working, scalable server designs used to power an internet and there is much to reuse. Although HTTP is typically served in a soft real-time manner, the state machine for the protocol is not too different from a state machine used to control a wireless telephony resource. So the interface description language is a little different, but with little modification the same architecture can power a wireless telephony application and a web application at the same time. The additional interface server is called Transaction Processing Nucleus (TPN) instead of Apache, the interface language is called TPNXML instead of HTML, but application development is no harder to for a developer to learn. In fact, you could probably call TPN an Interface Server or a Voice Server instead of an Application Server.

The development methodology is three tiered, and parallels web development closely. In fact, the same back end logic could be used. They all interface with humans. The same perl or python scripts could be used for CGI, TGI. When thinking a bit bigger, the same CORBA-based Object Web can be drawn upon to implement the business logic for all of these application servers. The objects drawn from the object web could be cgi scripts, tgi scripts or perhaps Enterprise Java beans.

System 100 Components will interact with currently used systems, not just our existing phone lines or phones, but with web and business software, network monitors, PDA's, office applications. A few components will have to be added to infrastructure to correct the typically lax web transaction environment and to interface to business logic systems like system 100.

One place system 100 differs from a web application platform is in the variety and sheer number of communications resources. It replaces HTTP protocol stack with drivers from a dozen hardware vendors and a dozen or so more protocol stacks for various VoIP and signaling functions. Then we have routing, directory services, applications, etc.

A thin Resource API directly encapsulating several common driver interfaces may be the simplest and most widely useful abstraction system 100 can offer. The actual implementation would be a library with a mid-sized APIs. In cases where processing power and execution size is at an absolute premium, the library could be gutted and only the necessary functions compiled into an application. The Resource Library is a useful concept and a System 100 Function.

To encapsulate a high-level protocol such as H.323, system 100 will encapsulate an H323 implementation API. Most hardware driver APIs do not employ the concepts of sessions, white-boards, or talking heads, so adding this to our Resource Manager Library would be a radical complexity increase. Effectively, an H323 implementation API is a superset of the Resource Library API. Protocol stacks like H323 require several network resources that most driver libraries do not. If system 100 is using H323, we can safely bet that the applications can reasonably access resources in real-time across the network. In these cases, a Resource Protocol might be a useful out of band interface to both the H323 implementation's API and the Resource Manager Library API. By Resource Protocol I mean a protocol that is a feature-replacement for the API. So a Resource Protocol library that encapsulates both VoIP protocols such as H.323 and Driver Resource Libraries could be developed for use on such a system. This might simplify life for the developer who has access to the Resource Protocol Library.

A control server, compression library, or application could be a system 100 component. An application component might have a certain structure, such as a flat xml file. As a component, it might be stored in a database, passed from one server to another, modified, and interpreted in one or more environments. We are planning to use CORBA for this type of object brokering. Some nice features of CORBA such as polymorphic messaging and method invocation will come in handy later on.

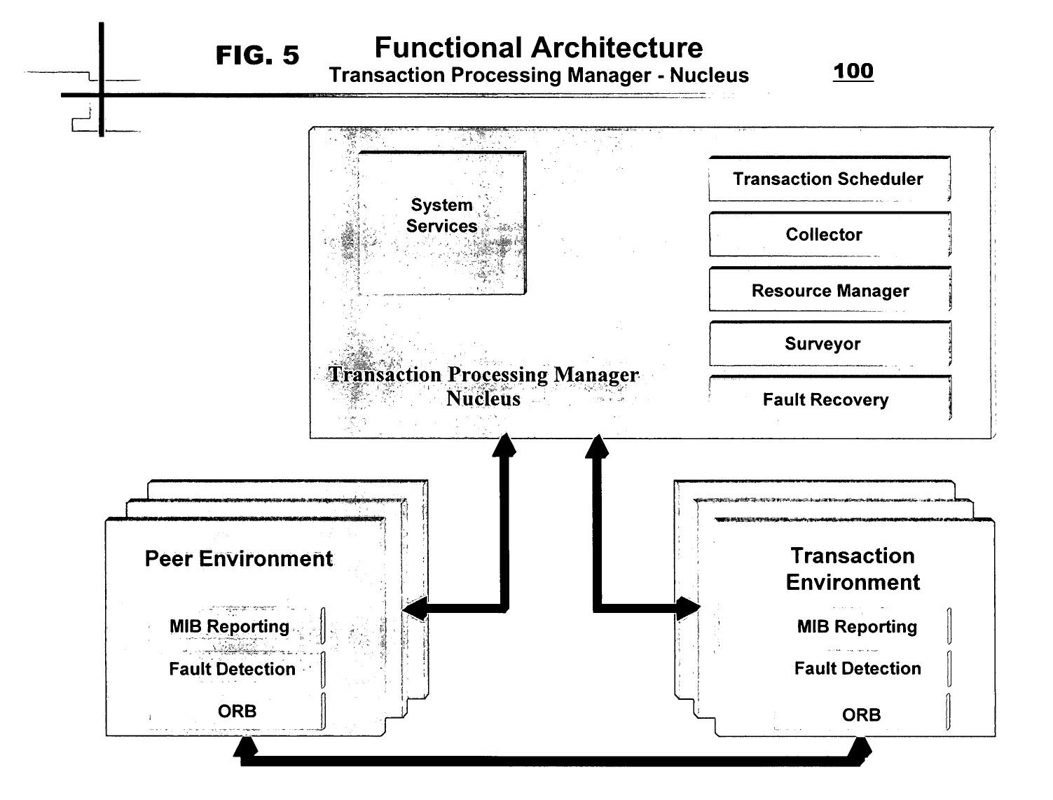

Referring to FIG. 5, the Application Server handles user interaction over the phone system and will be part of TPN. Any other server could plug as long as it is compatible with the System 100 interfaces. In order to do this we need to define all the interfaces to this server type. The Application Server is a very useful program stand-alone. The first few applications (which exist today) are fairly common examples of what an application server can do:

Medical Application

Integrated Messaging

Sales Automation—Integration of voice and web applications

TBD

Once we start talking about implementing entire call centers, we are looking at doing switching between disparate media streams while sending callers to agents, app servers, or queue servers.

System Components:

Switch—The most common application of a telephony switch is PBX. Among other things, a PBX “expands” a small number of “trunks” connected to the telephone network into a larger number of “station lines”. An example of this might be a few line-modems providing PSTN access to a dozen or more soft phone applications running on LAN-based workstations. Our first switch will be called “Soft-Switch”. Soft-Switch can be used as a “dumb” programmable switch or a “smart” switch. In it's dumb mode Soft-Switch informs a controller of every change of state and takes no call control action without direct instruction. We will decide on a protocol for controlling the “dumb” Soft-Switch later. In various smarter modes Soft-Switch will act as a registrar for terminals, a proxy server, and even an MCU. In a manner similar to that of TPN, Ipswich will accomplish smart behavior through scripting. Applications such as a PBX will be developed in that way.

Queue Server—As with the rest of the servers, the Queue Server will have embedded intelligence. For example, when an important task enters from a queue, it can be treated differently based on its importance, assigned priority. When a program pulls a task from a queue, it could be issued an appropriate task based on a comparison of the available tasks and the program's profile. An example of this kind of intelligent, non-queue-like behavior would be when a call of great priority comes in; it might and pulled to the front of the queue, and an appropriate agent might get a request to drop what it is doing and take the call out of the queue.

Transaction Scheduler—Upon receiving an invocation request for a given transaction, the scheduler determines the best execution resource, requests that the transaction be properly inserted into the resource execution queue, and that the required transaction be spawned.

Collector—Collects completion indications from various resources as transactions are completed. Directs the indication into the Resource Manager.

Resource Manager—Manages the availability of all shared system resources.

Surveyor—performance management tool obtains data from collector, refines it into performance records and stores it in database. Collected data is used for automatic system and network analyses, tuning and capacity planning. Performance and resource usage trends enable to forecast require capacity to support increased networks workloads.

Fault Recovery—Manages the fault recovery procedures for a given transaction based upon its fault recovery policies.

Peer Environment—An execution environment capable of servicing various Wizards. Within the Wizard is found a Peer Interface implementation that provides an externally usable interface to the Wizard.

Transaction Environment—An execution environment capable of servicing various Transactions.

MIB Reporting—Common mechanism for reporting either Peer Environment or Transaction Environment statistics.

Fault Detection—Common mechanism to support methods of redundancy and fault reporting.

ORB—Object Request Broker—Mechanism that guarantees delivery of requests and responses between one or more Peer Environments and one or more Transaction.

I claim:

1. A system, comprising:
a plurality of service independent building block components, wherein each service independent building block component is exclusive of being strictly associated with any particular type of service; and
means for using the plurality of service independent building block components in a structural hierarchy for purposes of providing a plurality of different services across a plurality of heterogeneous domains.

2. A method, comprising:
providing a plurality of service independent building block components, wherein each service independent building block component is exclusive of being strictly associated with any particular type of service; and
using the plurality of service independent building block components in a structural hierarchy for purposes of providing a plurality of different services across a plurality of heterogeneous domains.
